(19) United States
(12) Patent Application Publication
(10) Pub. No.: US 2026/0126663 A1
(43) Pub. Date: May 7, 2026

(54) HEAD-MOUNTED DISPLAY DEVICE

(71) Applicant: ASUSTeK COMPUTER INC., Taipei City (TW)

(72) Inventors: Yuan-Kai Yeh, Taipei City (TW); Chung-Lin Lee, Taipei City (TW); Peng Sun, Taipei City (TW)

(73) Assignee: ASUSTeK COMPUTER INC., Taipei City (TW)

(21) Appl. No.: 19/023,416

(22) Filed: Jan. 16, 2025

(30) Foreign Application Priority Data
Nov. 6, 2024 (TW) 113142425

(51) Int. Cl. G02B 27/01

(52) U.S. Cl. CPC G02B 27/0176

(57) ABSTRACT

Provided is a head-mounted display device. The head-mounted display device includes a head-mounted display, a control device, and an expansion battery. The control device includes a device battery and a controller. The controller controls operation of the head-mounted display. The expansion battery is detachably assembled to the control device. After the expansion battery and the control device are assembled, the expansion battery supplies power to the controller and charges the device battery.

### CROSS-REFERENCE TO RELATED APPLICATION

This application claims the priority benefit of Taiwan application serial no. 113142425, filed on Nov. 6, 2024. The entirety of the above-mentioned patent application is hereby incorporated by reference herein and made a part of this specification.

### BACKGROUND

### Technical Field

This disclosure relates to a wearable electronic device, and in particular to a head-mounted display device.

### Description of Related Art

Generally, a head-mounted display device includes a control device and a head-mounted display. The control device is disposed in the head-mounted display. The control device may drive or control the head-mounted display to provide an image. A device battery in the control device is used to provide power to the control device. It should be noted that the battery in the control device is inherently limited in size or weight due to wearable requirements. The battery in the control device is also limited in the duration it can supply power to the control device. As a result, the duration of use of the wearable display device is also limited.

### SUMMARY

The disclosure provides a head-mounted display device, capable of extending duration of use of the head-mounted display device.

In an embodiment of the disclosure, the head-mounted display device includes a head-mounted display, a control device, and an expansion battery. The control device includes a device battery and a controller. The controller is coupled to the device battery and the head-mounted display. The controller controls operation of the head-mounted display. The expansion battery and the control device are detachably assembled. After the expansion battery and control device are assembled, the expansion battery supplies power to the control device and charges the device battery.

Based on the above, after the expansion battery and the control device are assembled, the expansion battery can supply power to at least one of the controller and the device battery. Therefore, the duration of use of the head-mounted display device may be extended.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate example embodiments of the disclosure and, together with the description, serve to explain the principles of the disclosure.

FIG. 1 is a schematic diagram of a head-mounted display device according to an embodiment of the disclosure.

FIG. 2 is a schematic diagram of a control device and an expansion battery according to an embodiment of the disclosure.

FIG. 3 is a schematic diagram of a head-mounted display device according to an embodiment of the disclosure.

FIG. 4 is a schematic diagram of the use of a head-mounted display device according to an embodiment of the disclosure.

FIG. 5 is a schematic diagram of a head-mounted display device according to an embodiment of the disclosure.

FIG. 6 is a schematic diagram of a head-mounted display device according to an embodiment of the disclosure.

FIG. 7 is a schematic diagram of the use of a head-mounted display device according to an embodiment of the disclosure.

### DESCRIPTION OF THE EMBODIMENTS

Some embodiments of the disclosure are described in detail below with reference to the accompanying drawings. The reference numerals cited in the following description are regarded as the same or similar elements when the same reference numeral appears in different drawings. These embodiments are only part of the disclosure and do not disclose all possible implementations of the disclosure. Rather, these embodiments are merely examples within the claims of the disclosure.

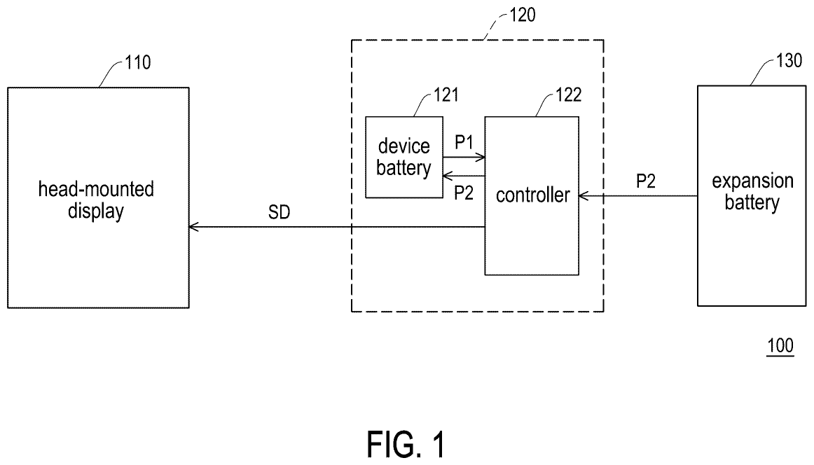

Referring to FIG. 1, FIG. 1 is a schematic diagram of a head-mounted display device according to an embodiment of the disclosure. In this embodiment, a head-mounted display device 100 includes a head-mounted display 110, a control device 120, and an expansion battery 130. The head-mounted display device 100 may be, for example, a helmet, glasses, or other head-mounted device known to those skilled in the art for use in virtual reality (VR), augmented reality (AR), mixed reality (MR), or extended reality (XR) applications. The head-mounted display 110 may be any type of display module applied to the head-mounted display device 100.

In this embodiment, the control device 120 includes a device battery 121 and a controller 122. The controller 122 is coupled to the device battery 121 and the head-mounted display 110. The controller 122 controls the operation of the head-mounted display 110. For example, the controller 122 can use a display signal SD to control the head-mounted display 110 to display an image. The expansion battery 130 and the control device 120 are detachably assembled. In this embodiment, after the expansion battery 130 and the control device 120 are assembled, the expansion battery 130 can supply power to the control device 120 and charge the device battery 121.

For example, after the expansion battery 130 and the control device 120 are assembled, the expansion battery 130 can provide bypass power supply to the control device 120 and charge the device battery 121 at the same time.

It is worth mentioning here that the controller 122 can receive one of electrical energy P1 from the device battery 121 and electrical energy P2 from the expansion battery 130. Therefore, the duration of use of the head-mounted display device 100 can be extended.

For example, during use of the head-mounted display device 100, the control device 120 drives the head-mounted display 110 and determines the power of the device battery 121. When the power of the device battery 121 is insufficient (for example, the power of the device battery 121 is lower than the low power threshold), the control device 120 can notify the user through the head-mounted display 110. Therefore, the user can assemble the expansion battery 130 to the control device 120. The controller 122 controls the transmission path of the electrical energy P2 of the expansion battery 130. Therefore, the expansion battery 130 supplies power to the controller 122 to maintain the normal operation of the head-mounted display device 100, and charges the device battery 121. In this embodiment, the expansion battery 130 can supply power to the controller 122 and charge the device battery 121 through the controller 122.

In some embodiments, when the power of the device battery 121 is insufficient, the expansion battery 130 can supply power to the controller 122 and directly charge the device battery 121.

When the power of the device battery 121 is sufficient (for example, the power of the device battery 121 is higher than the high power threshold), the controller 122 controls the expansion battery 130 to stop charging the device battery 121 and continue to supply power to the controller 122. After the expansion battery 130 and the control device 120 are assembled, the controller 122 receives, for example, a status signal indicating that the assembly is complete to receive the electrical energy P2 from the expansion battery 130 first. In other words, during the assembly of the expansion battery 130 and the control device 120, the device battery 121 is used as a backup battery. When the power of the expansion battery 130 is insufficient, the controller 122 receives the electrical energy P1 from the device battery 121.

In addition, when the expansion battery 130 is removed from the control device 120, the device battery 121 supplies power to the controller 122.

In this embodiment, the expansion battery 130 can be assembled with the control device 120 through magnetic force or any type of connector.

In this embodiment, the controller 122 is, for example, a central processing unit (CPU), or other programmable general-purpose or special-purpose microprocessor, digital signal processor (DSP), programmable controller, application specific integrated circuits (ASIC), programmable logic device (PLD), or other similar devices, circuit boards, or combinations of these devices.

In this embodiment, the device battery 121 is, for example, a lithium-ion (Li-ion) battery, a lithium-polymer (Li-polymer) battery, or other rechargeable batteries suitable for driving wearable devices, and the disclosure is not limited thereto. The expansion battery 130 is, for example, a mobile power supply well known to those skilled in the art, but the disclosure is not limited thereto. In this embodiment, the expansion battery 130 can supply wireless power or wired power to the control device 120.

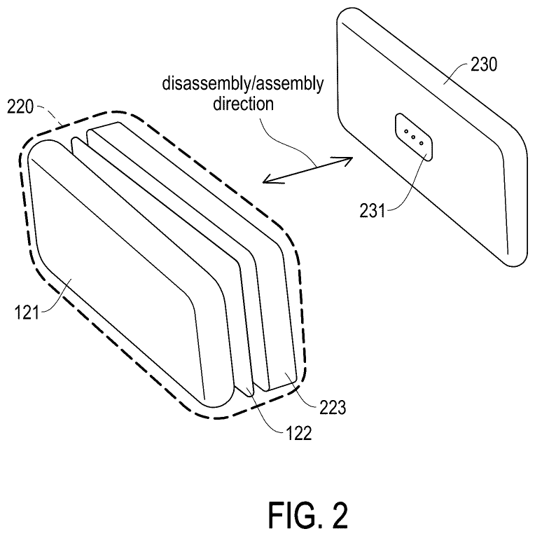

Referring to FIG. 2, FIG. 2 is a schematic diagram of a control device and an expansion battery according to an embodiment of the disclosure. In this embodiment, a control device 220 includes a device battery 121, a controller 122, and a heat dissipation module 223. An expansion battery 230 includes a magnetic attachment structure 231. The expansion battery 230 can be assembled on the control device 220 through the magnetic attachment structure 231. Further, the control device 220 also includes a magnetic structure (not shown). The expansion battery 230 can be fixed on the magnetic structure through the magnetic attachment structure 231.

In this embodiment, when the expansion battery 230 and the control device 220 are assembled, the heat dissipation module 223 dissipates heat for the controller 122 and the expansion battery 230. Furthermore, when the expansion battery 230 and the control device 220 are assembled, the heat dissipation module 223 is located between the controller 122 and the expansion battery 230. Therefore, the heat dissipation module 223 can dissipate heat for the controller 122 and the expansion battery 230 at the same time.

In this embodiment, the controller 122 is located between the heat dissipation module 223 and the device battery 121, but the disclosure is not limited thereto.

For example, the heat dissipation module 223 may include a fan and/or multiple heat dissipation fins, but the disclosure is not limited thereto.

In this embodiment, the implementation of the power supply of the device battery 121 and the expansion battery 230 is similar to the implementation of the power supply of the device battery 121 and the expansion battery 130 in the embodiment of FIG. 1, and therefore will not be repeated in the following.

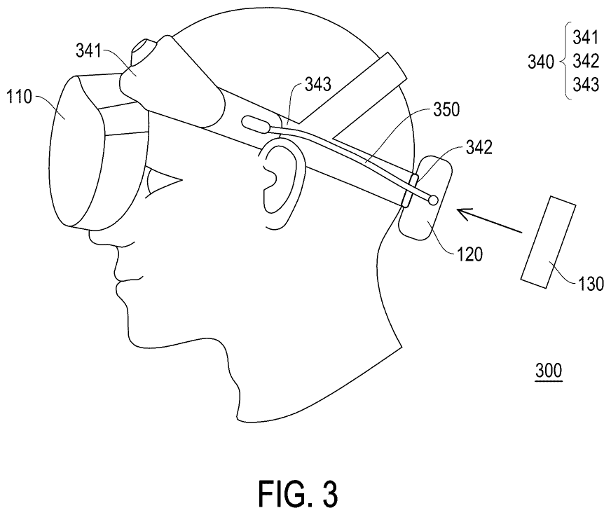

Referring to FIG. 1 and FIG. 3, FIG. 3 is a schematic diagram of a head-mounted display device according to an embodiment of the disclosure. In this embodiment, a head-mounted display device 300 includes a head-mounted display 110, a control device 120, an expansion battery 130, and a head fixing element 340. In this embodiment, the head fixing element 340 includes a first fixing part 341 and a second fixing part 342. The first fixing part 341 is used to fix the head-mounted display 110. The second fixing part 342 is used to fix the control device 120. In this embodiment, the first fixing part 341 is located on the first side of the head fixing element 340. The second fixing part 342 is located on the second side of the head fixing element 340. The second side is opposite to the first side.

Further, the head fixing element 340 also includes a strap 343. The first fixing part 341 is located on the front side of the strap 343 (i.e., the first side of the head fixing element 340). The second fixing part 342 is located on the rear side of the strap 343 (i.e., the second side of the head fixing element 340). Therefore, when the user puts on the head-mounted display device 300, the head-mounted display 110 corresponds to the face of the user. The control device 120 corresponds to the back of head of the user. The disclosure is not limited to the form of the head fixing element 340 of this embodiment. In some embodiments, the head fixing element 340 may be, for example, a helmet.

It is worth mentioning here that the head-mounted display 110 is fixed to the first fixing part 341. The control device 120 is separated from the head-mounted display 110 and fixed to the second fixing part 342. Therefore, the weight on the first side of the head fixing element 340 is reduced. Furthermore, the second side is opposite to the first side. The control device 120 balances the center of gravity of the head-mounted display device 300. In this way, when the head-mounted display device 300 is worn for a long time, the pressure on the face of the user can be reduced, thereby achieving a comfortable use experience.

In this embodiment, the head-mounted display device 300 also includes a connecting wire 350. The controller 122 can control the operation of the head-mounted display 110 through the connecting wire 350 and the head fixing element 340. For example, the controller 122 can provide the display signal SD to the head-mounted display 110 through the connecting wire 350 and the signal line (not shown) in the head fixing element 340 to control the head-mounted display 110. The controller 122 can receive the status of the head-mounted display 110 through the connecting wire 350 and the signal line in the head fixing element 340.

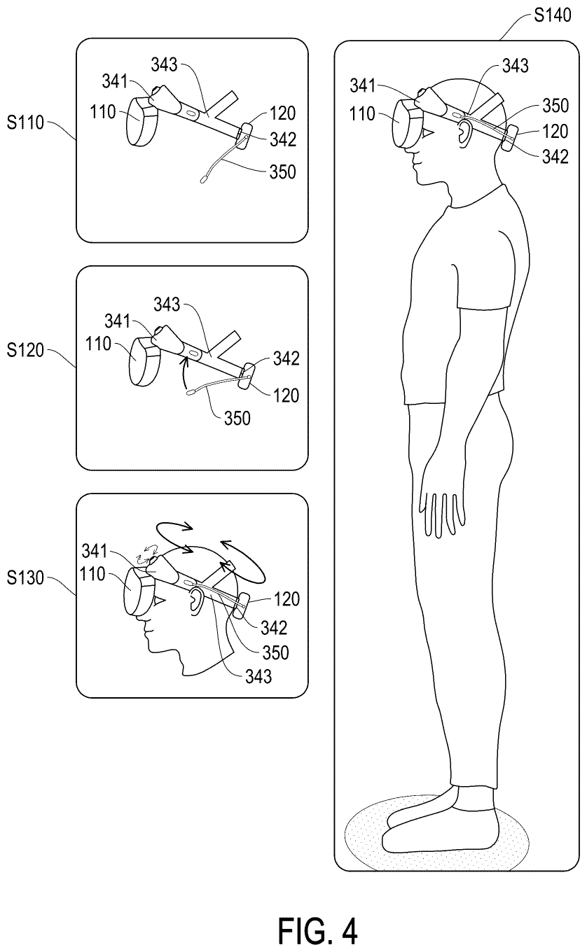

Referring to FIG. 1, FIG. 3, and FIG. 4, FIG. 4 is a schematic diagram of the use of a head-mounted display device according to an embodiment of the disclosure. In this embodiment, the use of the head-mounted display device 300 can be divided into steps S110 to S140, for example. In step S110, the control device 120 is fixed to the second fixing part 342. In step S120, the connection wire 350 is connected between the control device 120 and the head fixing element 340. In step S130, the head-mounted display device 300 is worn on the head of the user. The user can adjust the length and angle of the strap 343 of the head-mounted display device 300 to fit the head shape of the user. After step S130, the head-mounted display 110 corresponds to the face of the user. The control device 120 corresponds to the back of head of the user. In step S140, the user can start using the head-mounted display device 300.

When the power of the device battery 121 of the control device 120 is insufficient, the control device 120 can notify the user through the head-mounted display 110. Therefore, the user can assemble the expansion battery 130 to the control device 120. The implementation details of the power supply of the expansion battery 130 have been clearly explained in the embodiment of FIG. 1 and will not be repeated in the following. The expansion battery 130 may be assembled to the control device 120 by magnetic attachment, for example. The implementation details of the above assembly can be referred to the embodiment in FIG. 2.

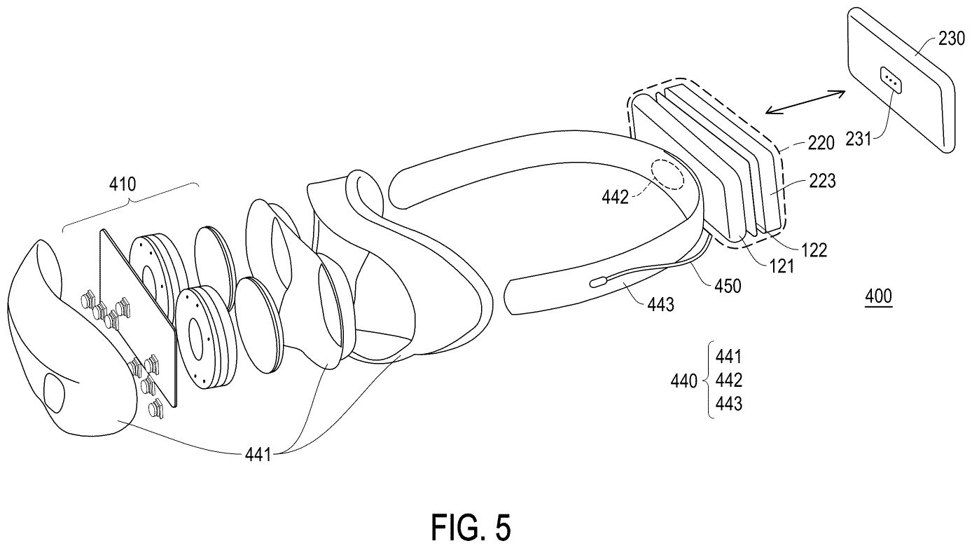

Referring to FIG. 5, FIG. 5 is a schematic diagram of a head-mounted display device according to an embodiment of the disclosure. In this embodiment, a head-mounted display device 400 includes a head-mounted display 410, a control device 220, an expansion battery 230, a head fixing element 440, and a connecting wire 450. The head fixing element 440 includes a first fixation part 441, a second fixation part 442, and a strap 443. The first fixing part 441 is located on the first side of the head fixing element 440. The first fixing part 441 may cover at least a part of the head-mounted display 410. The second fixing part 442 is located on the second side of the head fixing element 440. The second fixing part 442 can fix the control device 220 to the second side of the head fixing element 440. The implementation of the control device 220 and the expansion battery 230 has been clearly explained in the embodiment of FIG. 2, and therefore will not be repeated in the following.

In addition, the connecting wire 450 is connected between the control device 220 and the head fixing element 440. Therefore, the controller 122 of the control device 220 can control the head-mounted display 410 through the connection wire 450 and the signal wire (not shown) in the head fixing element 440. The head-mounted display device 400 is applicable to steps S110 to S140 in FIG. 4.

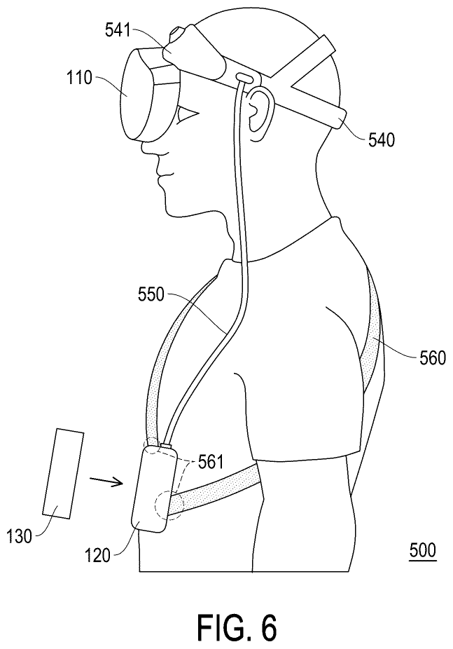

Referring to FIG. 1 and FIG. 6, FIG. 6 is a schematic diagram of a head-mounted display device according to an embodiment of the disclosure. In this embodiment, a head-mounted display device 500 includes a head-mounted display 110, a control device 120, an expansion battery 130, a head fixing element 540, a connecting wire 550, and a strap 560. The head fixing element 540 includes a first fixing part 541. The first fixing part 541 is used to fix the head-mounted display 110. The first fixing part 541 is located on the front side of the head fixing element 540. In this embodiment, when the user puts on the head-mounted display device 500, the head-mounted display 110 can correspond to the face of the user.

The strap 560 includes a second fixing part 561. The second fixing part 561 is used to fix the control device 120. When the user wears the strap 560, the second fixing part 561 can fix the control device 120 to the front side of the torso of the user. The disclosure is not limited to the form of the strap 560 in this embodiment.

The controller 122 can control the operation of the head-mounted display 110 through the connecting wire 550 and the head fixing element 540. For example, the controller 122 can provide the display signal SD to the head-mounted display 110 through the connecting wire 550 and the signal line (not shown) in the head fixing element 540 to control the head-mounted display 110. The controller 122 can receive the status of the head-mounted display 110 through the connecting wire 550 and the signal line in the head fixing element 540.

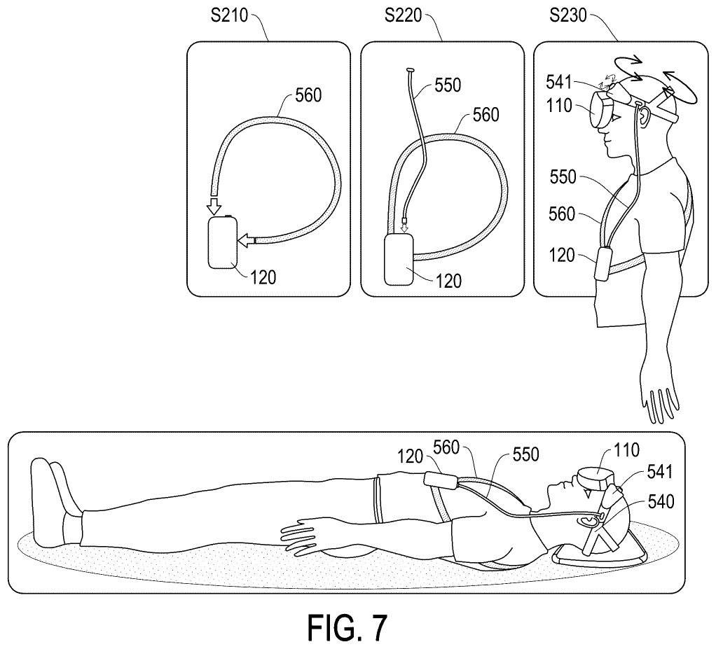

Referring to FIG. 1, FIG. 6, and FIG. 7, FIG. 7 is a schematic diagram of the use of a head-mounted display device according to an embodiment of the disclosure. In this embodiment, the use of the head-mounted display device 500 can be divided into steps S210 to S240. In step S210, the control device 120 is fixed to the second fixing part 561 of the strap 560. In step S220, one end of the connecting wire 550 is connected to the control device 120. In step S230, the other end of the connecting wire 550 is connected to the head fixing element 540. In step S230, the head fixing element 540 is worn on the head of the user. The user can adjust the length and angle of the head fixing element 540 to fit the head shape of the user. After step S230, the head-mounted display 110 corresponds to the face of the user. The control device 120 corresponds to the front side of the torso of the user. In step S240, the user can start using the head-mounted display device 500. It should be noted that the control device 120 corresponds to the front side of the torso of the user. Therefore, the user can use the head-mounted display device 500 while lying down.

When the power of the device battery 121 of the control device 120 is insufficient, the control device 120 can notify the user through the head-mounted display 110. Therefore, the user can assemble the expansion battery 130 to the control device 120. The implementation details of the power supply of the expansion battery 130 have been clearly explained in the embodiment of FIG. 1 and will not be repeated in the following. The expansion battery 130 may be assembled to the control device 120 by magnetic attachment, for example. The implementation details of the above assembly can be referred to the embodiment in FIG. 2.

In some embodiments, the control device 120 may be selectively secured to the rear side of the head fixing element 540. Therefore, the head-mounted display device 500 can also be applicable to steps S110 to S140 in FIG. 4.

To sum up, when the expansion battery and the control device are assembled, the expansion battery can supply power to at least one of the controller and the device battery. In this way, the duration of use of the head-mounted display device can be extended. In one embodiment, the head-mounted display is fixed to the first side of the head fixing element. The control device is detached from the head-mounted display and secured to the second side of the head-mounted element. Therefore, the weight on the first side of the head fixing element is reduced. Furthermore, the second side is opposite to the first side. The weight of the control device balances the center of gravity of the head-mounted display device. In this way, when the head-mounted display device is worn for a long time, the pressure on the face of the user can be reduced, thereby achieving a comfortable use experience. Additionally, in one embodiment, the control device is detached from the head-mounted display and positioned on the front side of the torso of the user. Therefore, the user can use the head-mounted display device while lying down.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A head-mounted display device, comprising:
a head-mounted display;
a control device, comprising:
a device battery; and
a controller, coupled to the device battery and the head-mounted display, configured to control operation of the head-mounted display; and
an expansion battery, detachably assembled with the control device,
wherein when the expansion battery and the control device are assembled, the expansion battery supplies power to the control device and charges the device battery.

2. The head-mounted display device according to claim 1, wherein when the expansion battery is detached from the control device, the device battery supplies power to the controller.

3. The head-mounted display device according to claim 1, wherein during assembly of the expansion battery and the control device, the controller preferentially receives electrical energy from the expansion battery.

4. The head-mounted display device according to claim 1, wherein the expansion battery comprises:
a magnetic attachment structure, wherein the expansion battery is assembled on the control device through the magnetic attachment structure.

5. The head-mounted display device according to claim 1, wherein the control device further comprises:
a heat dissipation module, wherein when the expansion battery and the control device are assembled, the heat dissipation module dissipates heat for the controller and the expansion battery.

6. The head-mounted display device according to claim 1 further comprising:
a head fixing element, comprising:
a first fixing part, configured to fix the head-mounted display; and
a second fixing part, configured to fix the control device.

7. The head-mounted display device according to claim 6, wherein:
the first fixing part is located on a first side of the head fixing element,
the second fixing part is located on a second side of the head fixing element, and
the second side is opposite to the first side.

8. The head-mounted display device according to claim 6 further comprising:
a connecting wire, wherein the controller controls the operation of the head-mounted display through the connecting wire and the head fixing element.

9. The head-mounted display device according to claim 1 further comprising:
a head fixing element, comprising:
a first fixing part, configured to fix the head-mounted display; and
a strap, comprising:
a second fixing part, configured to fix the control device.

10. The head-mounted display device according to claim 9, wherein when a user wears the strap, the second fixing part fixes the control device to a front side of torso of the user.
